(19) United States
(12) Patent Application Publication
(10) Pub. No.: US 2012/0291937 A1
(43) Pub. Date: Nov. 22, 2012

(54) PROCESS FOR MANUFACTURING AN ACOUSTIC PANEL FOR AN AIRCRAFT NACELLE

(75) Inventor: Emmanuel Drevon, Anglesqueville L'Esneval (FR)

(73) Assignee: AIRCELLE, Gonfreville l'Orcher (FR)

(21) Appl. No.: 13/515,154

(22) PCT Filed: Dec. 6, 2010
(86) PCT No.: PCT/FR2010/052619

§ 371 Date: Jun. 11, 2012

(30) Foreign Application Priority Data
Dec. 11, 2009 (FR) 09/05998

(51) Int. Cl. B05D 5/00; B32B 37/12; B05D 5/10

(52) U.S. Cl. 156/60; 427/287; 427/271; 427/207.1

(57) ABSTRACT

Process for manufacturing an acoustic panel for an aircraft nacelle. The invention relates to a process for manufacturing an acoustic panel (1) for a nacelle of an aircraft, said panel (1) comprising a metallic acoustic absorption structure (7) and an acoustic skin (3) having a multitude of acoustic openings (5), said process comprising: - a step A in which a layer (21) is formed that contains a polymerizable insulating material around the acoustic openings (5) of the acoustic skin (3), said insulating material being configured to protect the acoustic absorption structure (7) from corrosion; - a step B in which the layer (21) thus obtained is solidified by polymerization.

### TECHNICAL FIELD

The present invention relates to a process for manufacturing an acoustic panel for an aircraft nacelle.

### BACKGROUND

Aircraft turbojet engines create significant noise pollution. There is a strong demand to reduce this pollution, particularly given that the turbojet engines used are becoming more and more powerful. The design of the nacelle surrounding a turbojet engine contributes in large part to reducing this noise pollution.

In order to further improve the acoustic performance of aircrafts, nacelles are equipped with acoustic panels intended to attenuate the noise created by the turbojet engines.

Acoustic panels are sandwich-type structures well known for absorbing these noises. These panels usually comprise one or more layers of a cellular core structure (commonly called “honeycomb” structure). These layers are generally covered on their so-called outer surface with an air-impermeable skin, called “solid,” and on the inner surface thereof, i.e. the surface in contact with the flow of air and the sound excitation inside the engine, a perforated air-permeable skin, called “acoustic.”

The acoustic panel can also include several structural layers trapping the noise called “sound absorption layers,” between which a multi-perforated skin called “septum” is located. The sound absorption structure may be a cellular core structure containing a multitude of honeycomb cells. The septum is generally adhered between the noise-trapping structures by polymerization during the assembly/adhesion phase of the panel.

The acoustic panel is assembled by positioning the different skins and layers, which are then pasted on a mold having the appropriate shape. The assembly is then cured in a furnace so as to grip the layers and polymerize the adhesives.

Such panels make up acoustic resonators capable of “trapping” the noise and therefore attenuating the sound emissions toward the outside of the nacelle.

Typically, acoustic panels include an acoustic skin and a solid skin made from composite materials.

Acoustic panels are known in which the acoustic skin is already perforated before being assembled with the acoustic absorption structure. Examples include acoustic skins such as those described in application FR09/05605, the acoustic openings of which are formed during the manufacture of said skin.

It is common to use a metal acoustic absorption structure in this type of panel, in particular made from aluminum.

However, if the perforated acoustic skin made from a carbon-type composite material is in contact with the metal acoustic absorption structure, then a galvanic corrosion phenomenon occurs in which the acoustic skin made from the carbon-type composite acts as a cathode and the acoustic absorption structure made from metal acts as an anode. This causes a deterioration of the metal sound absorption structure and, as a result, of the acoustic panel.

It is therefore necessary to protect this type of panel from the galvanic corrosion phenomenon.

To that end, a continuous layer of fiberglass plies is usually inserted between the acoustic skin and the sound absorption structure. However, the acoustic openings of the acoustic skin being obstructed by the glass layer, it is necessary to perform a step for perforating said layer of glass, which is long and expensive.

In the case of an openwork skin like that described in application FR09/05605, the use of glass tapes appears relatively implausible, because such tapes require draping a significant number of glass plies to take into account the complex draping configuration of the composite plies of the acoustic panel so as to completely cover the latter part. Such a large number would also have an impact on the mass of the acoustic panel.

### BRIEF SUMMARY

One aim of the present invention is therefore to provide an acoustic panel including an acoustic skin having, before placement thereof, acoustic openings and a metal absorption structure, said panel being protected from the galvanic corrosion phenomenon.

To that end, according to a first aspect, the invention relates to a process for manufacturing an acoustic panel for a nacelle of an aircraft, said panel comprising a metallic acoustic absorption structure and an acoustic skin having a multitude of acoustic openings,

said process comprising:
a step A in which a layer is formed that contains a polymerizable insulating material around the acoustic openings of the acoustic skin, said insulating material being configured to protect the acoustic absorption structure from corrosion;
a step B in which the layer thus obtained is solidified by polymerization.

The panel obtained using the process according to the invention therefore includes an acoustic skin comprising, before the placement thereof, acoustic openings that are not obstructed during production of the acoustic panel. Said skin is not in contact with the metal acoustic absorption structure, but rather with the layer of polymerizable insulating material, which protects the acoustic absorption structure from corrosion without the placement of said insulating material causing any obstruction of the acoustic openings.

Advantageously, the process according to the invention makes it possible to provide an acoustic panel without a step for perforating the acoustic skin.

The invention thus makes it possible to simply provide protection against galvanic corrosion by means of the polymerizable insulating material inserted between the acoustic skin and the acoustic absorption structure without making the mass of the acoustic panel heavier, or increasing the number of steps to manufacture said panel.

According to other features of the invention, the panel according to the invention comprises one or more of the following optional features, considered alone or according to all possible combinations:
during the step A, the layer of insulating material deposited on the acoustic skin is heated;
the heating temperature is comprised between 50° C. and 200° C.;
in the step A, a broken layer of insulating material is deposited by spraying said insulating material on the acoustic skin so as to form a layer of insulating material around the acoustic openings;
in the step A, the layer of insulating material is formed around the acoustic openings by first depositing a continuous layer of insulating material on the entire surface of the acoustic skin, then freeing the acoustic openings thus obstructed by heating and/or blowing through said acoustic openings;
the polymerizable insulating material is chosen from among thermosetting materials with a base of epoxide, polyimide, or bismaleimide, and thermoplastic materials;
in the step B, the polymerization is done at a temperature higher than or equal to the ambient temperature and/or at a pressure greater than or equal to the ambient pressure, in an autoclave or stove;
before the step A, the acoustic skin is solidified by heating at a temperature between 100° C. and 250° C. and under a pressure between 2 bars and 8 bars;
during the step B, the acoustic skin and the layer of insulating material formed on said skin during the step (A) are solidified substantially simultaneously by polymerization;
a step in which the layer of adhesive material is formed on the layer of insulating material around the acoustic openings;
the layer of adhesive material is deposited by spraying around the acoustic openings;
a continuous layer of adhesive material is deposited on the layer of insulating material and the material obstructing the acoustic openings is removed by heating and/or blowing through said acoustic openings;
a layer of adhesive material is deposited on a continuous layer of insulating material;
in the step A, a layer consisting of a first ply of insulating material topped by a second ply of adhesive material is deposited, said first ply and second ply being configured to be polymerized during the step B;
the polymerization speed of the adhesive material is lower than that of the insulating material;
the adhesive material is chosen from among thermosetting materials with a base of epoxide, polyimide, or bismaleimide, and thermosetting materials;
the acoustic skin comprises a plurality of stacked layers of flat composite tapes each oriented by their longitudinal axis defining a direction, the longitudinal axes of the tapes of a same layer being parallel to one another, said tapes of the same layer being spaced apart from one another so as to have acoustic openings in the acoustic skin;
the process according to the invention comprises a step C in which the acoustic structure is fastened on the acoustic assembly obtained at the end of step B.

### BRIEF DESCRIPTION OF THE DRAWINGS

The invention will be better understood upon reading the following non-limiting description, done in reference to the appended figures.

FIG. 1 is a diagrammatic transverse cross-section of a panel obtained in the context of the present invention;

FIG. 2 is a diagrammatic transverse cross-section of an acoustic skin already including acoustic openings and a layer of a polymerizable insulating material in an embodiment of the step A of the process according to the invention;

FIG. 3 is a diagrammatic transverse cross-section of the layer of polymerizable insulating material mounted on the acoustic skin at the end of the step A;

FIG. 4 is a diagrammatic transverse cross-section of the acoustic skin fastened to the layer of insulating material of FIG. 3 at the end of an embodiment of the step B of the process according to the invention;

FIG. 5 is a diagrammatic transverse cross-section of the acoustic skin fastened to the layer of insulating material of FIG. 4 including a layer of adhesive material;

FIG. 6 is a diagrammatic transverse cross-section of the embodiment of FIG. 5 at the end of cross-linking of the layer of adhesive material;

FIG. 7 is a diagrammatic transverse cross-section of an embodiment of part of an acoustic panel obtained at the end of the process according to the invention according to the embodiments of FIGS. 1 to 6;

FIGS. 8 to 10 are diagrammatic transverse cross-sections of an alternative of the embodiments of FIGS. 3 to 6;

FIGS. 11 to 13 are diagrammatic transverse cross-sections of another alternative of the embodiments of FIGS. 3 to 6.

### DETAILED DESCRIPTION

The process according to the invention is intended to manufacture an acoustic panel 1 for a nacelle of an aircraft (not shown) comprising an acoustic skin 3 having acoustic openings 5, said skin 3 being fastened to a metal acoustic absorption structure 7, which in turn is fastened to a solid skin 9.

The acoustic skin 3 used in the process according to the invention is an acoustic skin having acoustic openings 5 before the placement of said skin 3 on the acoustic absorption structure 7 in the acoustic panel 1.

In this way, the acoustic skin 3 may have all types of acoustic openings 5. The acoustic openings 5 may assume any shape, as indicated above. Furthermore, the acoustic openings 5 may have a diameter comprised between 0.5 mm and 3.0 mm.

In particular, the acoustic skin may be of the type comprising a plurality of stacked layers of flat composite tapes each oriented by their longitudinal axis defining a direction, the longitudinal axes of the tapes of the same layer being parallel to one another, said tapes of said same layer being spaced apart from one another so as to have acoustic openings 5 in the acoustic skin 3, like the acoustic skins described in application FR09/05605.

In this way, the resin-impregnated fiber tapes are not attached edge to edge or by overlapping, but have spaces between them. In other words, the tapes of a same layer are not in contact with one another. The layers are alternated so as to obtain acoustic openings 5 in which the noise is capable of penetrating.

The acoustic absorption structure 7 can, for example, be a cellular core structure (see FIG. 1). The latter comprises a plurality of walls 11 forming the cells 13, which are configured to trap the noise.

The acoustic absorption structure 7 is made from a metal material, such as aluminum.

The solid skin 9 is typically made by superimposing a multitude of composite plies, in particular made up of resin-impregnated carbon fiber fabrics, in particular of the epoxide, polyimide or bismaleimide type.

Contrary to the acoustic skin 3, the solid skin 9 does not comprise acoustic openings 5.

The process according to the invention includes:
a step A in which a layer 21 is formed containing a polymerizable insulating material around acoustic openings 5 of the acoustic skin, said insulating material being configured to protect the acoustic absorption structure 7 from corrosion, while ensuring a physical separation between the acoustic skin 3 and the acoustic absorption structure 7;
a step B in which the layer 21 thus obtained is solidified by polymerization.

The process according to the invention therefore makes it possible to use an acoustic skin 3 having acoustic openings 5 before the placement and fastening thereof in the acoustic panel 1.

In particular, the process according to the invention makes it possible to provide an acoustic skin 1 without comprising a step for perforating the acoustic skin 3, since the acoustic openings 5 thereof are not obstructed during the manufacture of said panel 1.

The invention then makes it possible to simply provide protection against galvanic corrosion of the acoustic absorption structure 7 by means of a polymerizable insulating material without making the mass of the acoustic panel 1 heavier, or increasing the number of steps in the production of said panel 1.

Typically, the layer of insulating material 21 has a thickness comprised between 0.04 mm and 0.32 mm.

Typically, the polymerizable insulating material is a material chosen from among thermosetting materials with a base of epoxide, polyimide or bismaleimide, and thermoplastic materials.

According to one embodiment, during the step A, the layer of insulating material 21 deposited on the acoustic skin 3 is heated. Heating this layer 21 makes it possible to start a sufficient pre-polymerization to impart good cohesion to said layer, or even also softening. In this way, the assembly formed by the acoustic skin 5 topped by the layer of insulating material 21 is easier to handle.

Typically, the heating temperature is between 50° C. and 200° C. It is also possible for the insulating material to be able to pre-polymerize, in other words to begin polymerization, at ambient temperature.

According to one embodiment, in the step A, a broken layer of insulating material 21 is deposited by spraying said insulating material on the acoustic skin 3 so as to form a layer of insulating material 21 around the acoustic openings 5. As a result, the layer of insulating material 21 is formed around the acoustic openings 5 in a single step. In fact, the sprayed material attaches on the material of the acoustic skin 3, and therefore around the acoustic openings 5.

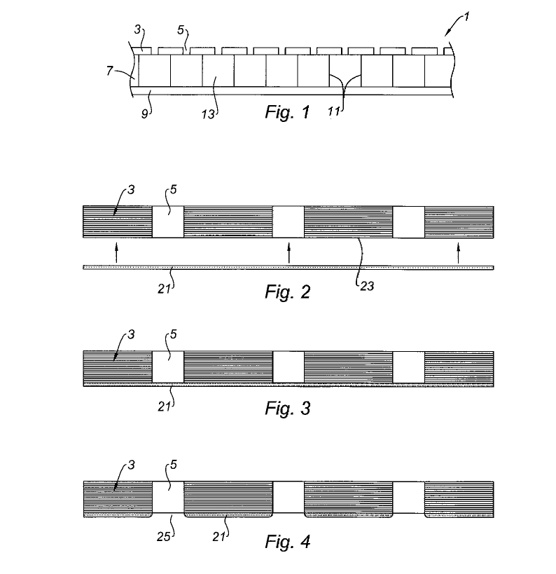

According to the embodiment of the process of the invention illustrated in FIGS. 2 to 7, in a step A, the layer of insulating material 21 is formed around the acoustic openings 5 by first depositing a continuous layer of insulating material 21 on the entire surface of the acoustic skin 3, then freeing the acoustic openings 7 thus obstructed by heating and/or blowing through said acoustic openings 7.

The layer of insulating material 21 is advantageously deposited on the surface 23 of the acoustic skin 3 intended to be fastened on the acoustic absorption structure 7.

It is possible for only heating or only blowing to be necessary to form the acoustic openings 25 by removing the material that was obstructing said openings.

In fact, the heating and/or blowing makes it possible to create piercings in the material of the layer of isolating material 21 that obstruct the acoustic openings 5. The material is then pressed on the edges of the acoustic openings 5. As a result, the layer of insulating material 21 is formed around each acoustic opening 5 without obstructing it.

The heating temperature can be between 50° C. and 200° C.

The blowing can be done using a nozzle moved manually or automatically.

The continuous layer of insulating material 21 can be deposited manually or automatically, for example using rollers.

The acoustic skin 3 used in this embodiment can be solidified by polymerizing it before adding the layer of insulating material 21, i.e. before the step A, which makes it possible to apply the layer of insulating material 21 more easily. The polymerization typically comprises of heating said skin 3 to a temperature between 100° C. and 250° C. under a pressure comprised between 2 bars and 8 bars

According to one embodiment not shown, the acoustic skin 3 is not polymerized before the step A, i.e. before the deposition of the layer of insulating material 21, but rather during this step B with the layer of insulating material 21 obtained at the end of the step A. Thus, during the step B, the acoustic skin 3 and the layer of insulating material 21 can be polymerized substantially simultaneously. Advantageously, the number of steps of the inventive process is thereby limited.

As illustrated in FIG. 3, during the step A, the layer of insulating material 21 obstructs the acoustic openings 5 of the acoustic skin.

At the end of the step A, the layer of insulating material 21 is deposited only on the material of the acoustic skin 3 and no longer obstructs the acoustic openings 5. In other words, the layer of insulating material 21 has acoustic openings 25 with a substantially equal diameter, or a diameter that may even be larger than that of the acoustic openings 5 of the acoustic skin. In this way, the diameter of the acoustic openings 25 of said layer is comprised between 0.5 mm and 3.0 mm.

During the step B, the layer of insulating material 21 is solidified secured on said skin 3, and possibly the acoustic skin 3, by polymerization. The polymerization then consists of heating to a temperature between 100° C. and 250° C. under a pressure between 2 bars and 8 bars.

The process can then include an additional step C in which the acoustic structure 7 is fastened on the acoustic assembly obtained at the end of the step B. To that end, it is possible to apply a layer of adhesive material on the layer of insulating material 21 or on the acoustic absorption structure 7.

The adhesive material must make it possible to fasten the layer of insulating material 21 by adhering it on the metal absorption structure 7. Said adhesive material can be chosen from among thermosetting materials with a base of epoxide, polyimide or bismaleimide, and thermosetting materials.

The process according to the invention can comprise a step in which a layer of adhesive material is formed on the layer of insulating material 21 around the acoustic openings 25; 35 in order to preserve the latter.

Typically, the layer of adhesive material 31 has a thickness between 0.04 mm and 0.32 mm.

The process according to the invention may include a step in which a layer of adhesive material 31 is deposited on the layer of insulating material 21. Said layer of insulating material 21 may or may not already be polymerized following the step B.

According to one embodiment, the layer of adhesive material may be deposited by spraying around the acoustic openings 5, 25.

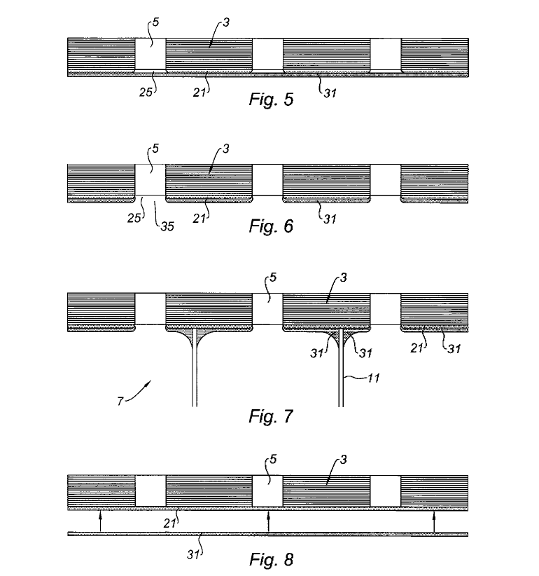

As illustrated in FIG. 5, a continuous layer of adhesive material 31 may be deposited on the layer of insulating material 21. The layer of adhesive material 31 then obstructs the acoustic openings 5 and 25.

In order to free said openings 5 and 25, it is possible to heat and/or blow through the acoustic openings 5. The heating temperature may be between 50° C. and 200° C.

Thus, as illustrated in FIG. 6, the layer of adhesive material 31 has acoustic openings 35 in the extension of the acoustic openings 5 and 25. The diameter of said acoustic openings 35 is typically substantially equal to or larger than the diameter of the acoustic openings 5 and 25, in particular between 0.5 mm and 3.0 mm.

As illustrated in FIG. 7, the acoustic absorption structure 7 is placed on the layer of adhesive material 31. The assembly can then be heated to a temperature between 100° C. and 250° C. at a pressure between 2 bars and 4 bars so as to polymerize the layer of adhesive material to fasten the layer of adhesive material 31 by adhesion on the acoustic absorption structure 7. Thus, in the case of a cellular core structure, the layer of adhesive material 31 forms a meniscus at the end of the walls 11 of the cells in contact with said layer 31 without obstructing said cells 13.

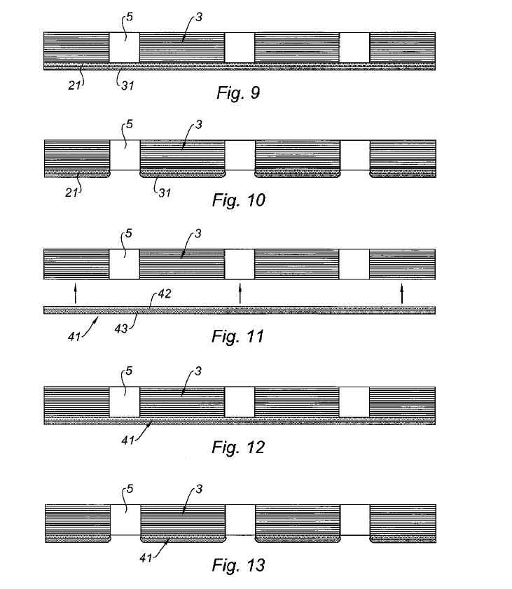

According to one alternative illustrated in FIGS. 8 and 9, a layer of adhesive material 31 separate from the layer of insulating material 21 is applied on the latter. The layer of adhesive material 31 and the layer of insulating material 31 do not have acoustic openings 35 and both obstruct the acoustic openings 5 of the acoustic skin.

The acoustic openings 25, 35 are then formed in a single step in the layers of insulating material 21 and adhesive material 31, in particular by heating and/or blowing, as indicated above.

In the step B, the assembly formed by the layer of insulating material 21 and the layer of adhesive material 31 is polymerized (see FIG. 10).

As a result, the layer of insulating material 21 and the layer of adhesive material 31 are deposited only on the material of the acoustic skin 3 and therefore no longer obstruct the acoustic openings 5.

The adhesive material can advantageously be slower to polymerize than the insulating material. In other words, the insulating material may have a higher polymerization speed than the polymerization speed of the adhesive material, such that the adhesive material solidifies during adhesion of the acoustic absorption structure 7 and not before that assembly step. In fact, if the adhesive material is in too advanced a stage of polymerization, the fastening of the acoustic absorption structure 7 on the layer of adhesive material 31 creates periodic depositions of glue that are detrimental to the gluing, and therefore the adhesion of the acoustic panel 1.

The adhesive material may be chosen from among thermosetting materials with a base of epoxide, polyimide or bismaleimide, and thermosetting materials. The acoustic structure 7 can then be placed and glued on the layer of adhesive material 31 as indicated above, the gluing being able to be done under heating at a temperature between 100° C. and 250° C. and under pressure between 2 bars and 4 bars.

In an alternative illustrated in FIGS. 11 and 10, in the step A, a single layer 41 may be deposited made up of a first ply 42 of insulating material and a second ply 43 of adhesive material configured to be polymerized during the step B, said second ply 43 topping the first ply 42.

At the end of the step A, the layer 41 no longer obstructs the acoustic openings 5. As a result, the number of steps of the process according to the invention is further reduced. As before, the adhesive material may be slower to polymerize than the insulating material.

During the step B, the polymerization of the insulating material may be done by heating or at ambient temperature by allowing sufficient rest time. In the event heating is necessary, the temperature is between 50° C. and 200° C.

In the step B, the polymerization may be done at a temperature higher than or equal to the ambient temperature and/or a pressure greater than or equal to the ambient pressure, in an autoclave or a stove.

More specifically, the polymerization may be done at ambient temperature or pressure.

The polymerization may be done in an autoclave at a temperature and pressure substantially higher than the ambient temperature and pressure.

The polymerization may be done in a stove at a temperature substantially higher than the ambient temperature and ambient pressure.

The embodiments described may of course be considered alone or combined with one another without going beyond the scope of the invention. To that end, for example, it is possible to spray the layer of insulating material on the acoustic skin and, at the same time or later, to spray the adhesive material or deposit the layer of adhesive material in film form. It is also possible, after depositing the layer of insulating material in film form, to spray the adhesive material.

1. A process for manufacturing an acoustic panel for a nacelle of an aircraft, said panel comprising a metallic acoustic absorption structure and an acoustic skin having a multitude of acoustic openings,
said process comprising:
a step A in which a layer is formed that contains a polymerizable insulating material around the acoustic openings of the acoustic skin, said insulating material being configured to protect the acoustic absorption structure from corrosion;
a step B in which the layer thus obtained is solidified by polymerization.

2. The method according to claim 1, wherein, during the step A, the layer of insulating material deposited on the acoustic skin is heated.

3. The method according to claim 1, wherein the heating temperature is comprised between 50° C. and 200° C.

4. The method according to claim 1, wherein, in the step A, a broken layer of insulating material is deposited by spraying said insulating material on the acoustic skin so as to form a layer of insulating material around the acoustic openings.

5. The method according to claim 1, wherein in the step A, the layer of insulating material is formed around the acoustic openings by first depositing a continuous layer of insulating material on the entire surface of the acoustic skin, then freeing the acoustic openings thus obstructed by heating and/or blowing through said acoustic openings.

6. The method according to claim 1, wherein the polymerizable insulating material comprising a thermosetting materials with a base of at least one of epoxide, polyimide, or bismaleimide, and thermoplastic materials.

7. The method according to claim 1, wherein, in the step B, the polymerization is done at a temperature higher than or equal to the ambient temperature and/or at a pressure greater than or equal to the ambient pressure, in an autoclave or stove

8. The method according to claim 1, wherein before the step A, the acoustic skin is solidified by heating at a temperature between 100° C. and 250° C. and under a pressure between 2 bars and 8 bars.

9. The method according to claim 1, wherein, during the step B, the acoustic skin and the layer of insulating material formed on said skin during the step are solidified substantially simultaneously by polymerization.

10. The method according to claim 1, comprising a step in which a layer of adhesive material is formed on the layer of insulating material around the acoustic openings.

11. The method according to claim 10, wherein the layer of adhesive material is deposited by spraying around the acoustic openings.

12. The method according to claim 10, wherein a continuous layer of adhesive material is deposited on the layer of insulating material and the material obstructing the acoustic openings is removed by heating and/or blowing through said acoustic openings.

13. The method according to claim 12, wherein a layer of adhesive material is deposited on a continuous layer of insulating material.

14. The method according to claim 1, wherein in the step A, a layer consisting of a first ply of insulating material topped by a second ply of adhesive material is deposited, said first ply and second ply being configured to be polymerized during the step B.

15. The method according to claim 10, wherein the polymerization speed of the adhesive material is lower than that of the insulating material.

16. The method according to claim 15, wherein the adhesive material comprises a thermosetting material& with a base of at least one of epoxide, polyimide, or bismaleimide, and thermosetting materials.

17. The method according to claim 1, wherein the acoustic skin comprises a plurality of stacked layers of flat composite tapes each oriented by their longitudinal axis defining a direction, the longitudinal axes of the tapes of a same layer being parallel to one another, said tapes of the same layer being spaced apart from one another so as to have acoustic openings in the acoustic skin.

18. The method according to claim 1, comprising a step C in which the acoustic structure is fastened on the acoustic assembly obtained at the end of step B.
